(19) United States
(12) Patent Application Publication
(10) Pub. No.: US 2022/0325577 A1
(43) Pub. Date: Oct. 13, 2022

(54) METHOD FOR CONTROLLING CURTAIN POSITION

(71) Applicant: WEN YING LIANG, Changhua County (TW)

(72) Inventor: WEN YING LIANG, Changhua County (TW)

(73) Assignee: CHING FENG HOME FASHIONS CO., LTD., Changhua County (TW)

(21) Appl. No.: 17/382,226

(22) Filed: Jul. 21, 2021

(30) Foreign Application Priority Data
Apr. 7, 2021 (TW) 110112521

(51) Int. Cl. E06B 9/38; E06B 9/262; H02P 3/06

(52) U.S. Cl. CPC E06B 9/38; E06B 9/262; H02P 3/06; E06B 2009/2622; E06B 2009/2625

(57) ABSTRACT

A method for controlling curtain position of a curtain assembly includes a motor and a control unit. The motor includes a detection unit for detecting the working current of the motor. When the curtain moves upward and stops, the detection unit detects the working current increases. The detection unit sends a signal to a processor of the control unit to judge that the curtain reaches the upper-most position. Then the control unit stops the motor and demands the motor to operate reversely a range to lower the curtain slightly. The curtain that is lowered by operating the motor reversely is defined as at a limited position. When the curtain is lowered by the motor, the lower-most position of the curtain is defined by a pre-set number of revolutions of the motor. The pre-set number of revolutions of the motor is set by the control unit.

### BACKGROUND OF THE INVENTION

### 1. Fields of the Invention

The present invention relates to a method for controlling the curtain position, and more particularly, to a method for controlling the limited position and lower most positions of the curtain.

### 2. Descriptions of Related Art

The conventional electric window curtain includes a motor and a control module wherein the control module controls the forward/reverse rotation of the motor so as to control the rotation of the scrolling member to retract or release the rope to position the curtain position.

Since all of the electric curtains of standard sizes are mass-produced, the assembling personnel must set the ascending or descending length of the curtain according to the length of the curtain. Generally, the motor control module is set to operate in a pre-set pattern. Alternatively, limit switches are used to control the position of the curtain. However, all of the aforementioned methods is complicated and requires human operation. It is somehow inconvenient for the users and the users usually try and correct the operation frequently.

The present invention intends to provide a method for controlling the curtain position to eliminate shortcomings mentioned above.

### SUMMARY OF THE INVENTION

The present invention relates to a method for controlling the curtain position of a curtain assembly. The curtain assembly comprises a motor and a control unit. The control unit controls forward/reverse rotation of the motor to activate a scrolling member of the curtain assembly to operate a rope to lift or lower a curtain of the curtain assembly. The motor includes a detection unit which detects working current of the motor. The working current of the motor varies along with different load of the motor. When the curtain moves upward and stops, the load of the motor increases and the detection unit detects the working current increases. The detection unit sends a signal to a processor of the control unit to judge that the curtain reaches an upper-most position. Then the control unit stops the motor and demands the motor to operate reversely a range to lower the curtain. The curtain that is lowered by operating the motor reversely as at a limited position. When the curtain is lowered by the motor, the lower-most position of the curtain is defined by a pre-set number of revolutions of the motor. The pre-set number of revolutions of the motor is set by the control unit.

Preferably, the working current of the motor is 0.5 to 2 Amp when the curtain moves upward and stops.

Preferably, the range that the motor operates reversely is to lower the curtain 3 to 20 mm.

Preferably, the curtain is lowered to a position by setting the number of revolutions of the motor.

The manufacturers set the curtain by the method before handing the curtains to customers. The upper most position and the limited position of the curtain are determined by the detection unit detecting the working current of the motor and by slightly lower the curtain from the upper-most position. The lower-most position of the curtain is defined when the curtain is lowered by the motor operating a pre-set number of revolutions of the motor. And the lower most position is the final position that the curtain can be lowered.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows that the curtain reaches its upper-most position;

FIG. 2 shows that the curtain reaches its lower-most position, and

FIG. 3 illustrates the steps of the method of the present invention.

### DETAILED DESCRIPTION OF THE PREFERRED EMBODIMENT

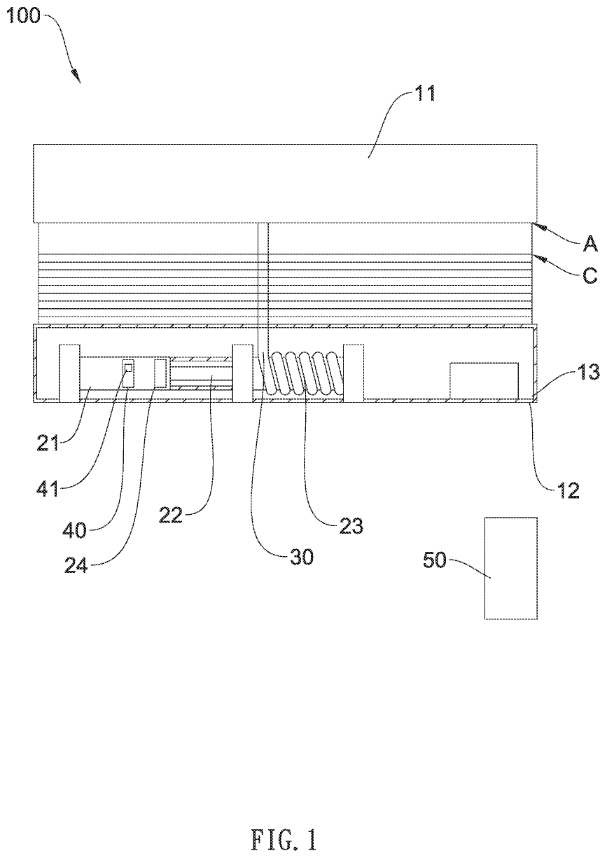

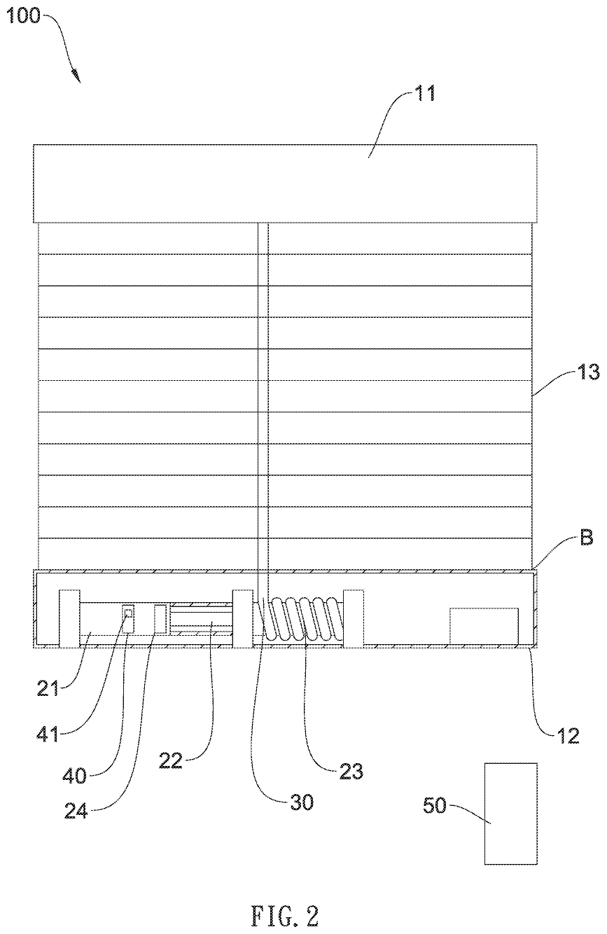

Referring to FIGS. 1 and 2, the present invention discloses a method for controlling the curtain position of a curtain assembly 100, wherein the curtain assembly 100 comprises a top rail 11, a bottom rail 12, a curtain 13 connected between the top and bottom rails 11, 12.

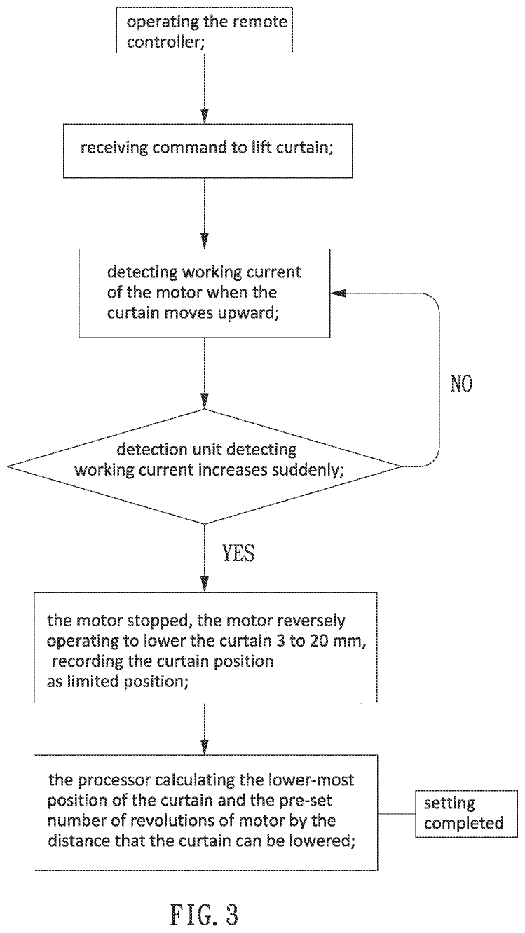

A motor 21, a shaft 22 and a scrolling member 23 are located in the bottom rail 12. The scrolling member 23 is wrapped with a rope 30. The motor 21 is controlled by a control unit 40 which is installed in the motor 21 and includes a micro-control unit (MCU) and multiple wireless control chips. The control unit 40 includes multiple micro-chips installed in the motor 21 to reduce the volume of the motor 21 and to save space and weight. As shown in FIGS. 1 and 3, the users may use a remote controller 50 to control the control unit 40 to operate the curtain assembly 100.

The motor 21 includes a detection unit 24 which can be a Hall Effect current sensor or non-contact current sensor to detect the working current of the motor 21. When the motor 21 operates normally, the working current is within a range of 0.1 to 1 Amp to control the curtain 13 to be lifted or lowered. The detection unit 24 is a micro-chip located in the motor 21 to minimize the motor 21.

As shown in FIGS. 1 to 3, the users control the remote controller 50 to activate the control unit 40 to move. The detection unit 41 detects any working current of the motor 21 that suddenly increases. When the curtain 13 moves upward and stops at the bottom of the top rail 11 as shown in FIG. 1, the load of the motor 21 increases and the detection unit 24 detects the working current increases to 0.5 to 2 Amp. The detection unit 24 sends a signal to the processor 41 of the control unit 40 to judge that the curtain 13 reaches an upper-most position “A”, then the control unit 40 stops the motor 21 and demands the motor 21 to operate reversely a range to lower the curtain 13. The range that the motor 21 operates reversely is to lower the curtain 13 within the range of 3 to 20 mm, and this position where the curtain 13 is lowered by operating the motor reversely is defined as a limited position “C”. The purpose that the curtain 13 is slightly lowered is to prevent the curtain assembly 100 from being tighten status constantly and also to protect the motor 21 from being burned or operating abnormally.

As shown in FIG. 2, the distance that the curtain 13 is lowered is defined by the motor 21 operating a pre-set number of revolutions. The processor 41 of the control unit 40 calculates the lower-most position “B” of the curtain 13 by the distance that the curtain 13 will move downward. The lower-most position “B” of the curtain 13 is therefore set by the motor 21 operating a pre-set number of revolutions, and the pre-set number of revolutions of the motor 21 is set by the processor 41 of the control unit 40. The lower-most position “B” is the final position that the curtain 13 can be lowered.

The method of the present invention uses the detection unit 24 to detect the working current of the motor 21 during the upward movement of the curtain 13 to define the limited position “C”. According to the needs of the distance that the curtain 13 is required to be lowered, the lower-most position “B” of the curtain 13 is set by the motor 21 operating a pre-set number of revolutions. The method is simple and easily to proceed.

The users may set the desired position of the curtain 13 between the limited position “C” and the lower-most position “B” by the remote controller 50 to prevent the curtain assembly 100 and the motor 21 from being damaged.

The advantages of the present invention are that the because the upper-most position “A” is set by the detection of the working current of the motor 21, and then the limited position “C” is set when the curtain 13 reaches the upper-most position “A”. Therefore, no extra limit switches or computer programs are needed. This is friendly to users and the installers.

The lower-most position “B” of the curtain 13 is set by the motor 21 operating a pre-set number of revolutions, so that the curtain 13 can precisely reach the desired position when the users need privacy and block light from outside of the room.

While we have shown and described the embodiment in accordance with the present invention, it should be clear to those skilled in the art that further embodiments may be made without departing from the scope of the present invention.

What is claimed is:

1. A method for controlling the curtain position of a curtain assembly, the curtain assembly including a motor and a control unit, the control unit controlling forward/reverse rotation of the motor to activate a scrolling member of the curtain assembly to operate a rope to lift or lower a curtain of the curtain assembly;
wherein the motor includes a detection unit which detects working current of the motor, the working current of the motor varies along with different loads of the motor, when the curtain moves upward and stops, the load of the motor increases and the detection unit detects the working current increases, the detection unit sends a signal to a processor of the control unit to judge that the curtain reaches an upper-most position, then the control unit stops the motor and demands the motor to operate reversely a range to lower the curtain, the control unit records the curtain that is lowered by operating the motor reversely as at a limited position, and
a lower-most position of the curtain is defined by a pre-set number of revolutions of the motor, the pre-set number of revolutions of the motor is set by the control unit.

2. The method as claimed in claim 1, wherein the working current of the motor is 0.5 to 2 Amp when the curtain moves upward and stops.

3. The method as claimed in claim 2, wherein the range that the motor operates reversely is to lower the curtain 3 to 20 mm.

4. The method as claimed in claim 1, wherein the curtain is lowered to a position by setting the number of revolutions of the motor.
